(19) United States
(12) Patent Application Publication
(10) Pub. No.: US 2003/0062985 A1
(43) Pub. Date: Apr. 3, 2003

(54) Safety lock with blind keyhole remote-controlled by transmitter or telephone

(76) Inventor: Shuquan Luo, GuangZhou (CN)

Correspondence Address: RABIN & BERDO, P.C., 1101 14th Street, N.W., Suite 500, Washington, DC, 20005, US

(21) Appl. No.: 10/004,407

(22) Filed: Dec. 6, 2001

(30) Foreign Application Priority Data
Sep. 30, 2001 (CN) 01 1 29721.2

(51) Int. Cl. H04Q 1/00; G05B 19/00

(52) U.S. Cl. 340/5.26

(57) ABSTRACT

The present invention provides a safety lock with blind keyhole remote-controlled by transmitter or telephone. It is characterized by the fact that it includes rolling code transmitting and receiving circuits, telephone decoding control circuit, and inner moving cock and outer stationary case fixed with movable cross-bolted pin in the lock-ball chamber of lock-internals. The present invention is novel in design and structure and convenient for use. It keeps absolute secrecy and is the only and most reliable safety lockset.

### BACKGROUND

The present invention relates to a kind of lockset, especially a safety lock with blind keyhole remote-controlled by transmitter or telephone.

Locks of current technology, especially the door lock is easy to unlock with a universal key or by the way that injecting a special chemical into the keyhole, which will be solidified and shaped in 20 seconds to copy the key profile and taken to make keys for unlocking. Remote controller that adopts coder (digital coder) of hour and minute system is also utilized in current technology. But the cipher transmitted is unchanged with only 2⁸ digits, which can be all decoded in 32 seconds of one round of transmission by codescanner, resulting losing secrecy and safety. The current keyboard encrypted lock and computer encrypted lock are easy to be damaged from moisture due to the exposed plastic keyboard, and therefore they are usually only used indoors where is not affected with damp. The present contact-type or non-contact radio type IC card lock can be tracked and captured in 26 seconds by codegraber and therefore the encrypted code will be broken. Furthermore, for high-cost fingerprint identification lock, if master's registered fingerprint hurts, or the identification window is worn out, its resolution will be decrease, causing lost control.

The object of the present invention is to overcome the shortcomings of current technology and provide a kind of safety lock with blind keyhole remote-controlled by transmitter or telephone with high secrecy and non-copied key.

### SUMMARY

The goal of the present invention is realized in such a way:

This safety lock with blind keyhole remote-controlled by transmitter or telephone is characterized by the fact that it includes rolling code transmitting and receiving circuits, telephone decoding control circuit, and inner moving cock 1 and outer stationary case 2 fixed with movable cross-bolted pin 3 in the lock-ball chamber of lock-internals.

Said lock-internals include blind-hole spring 3, blind-hole pin press-spring 4, key positioning cross-groove 11 with unequal distance, and tension flexible-shaft 5 of blind-hole pin. It also includes inner locking ball 7, outer locking ball 8, locking ball's press-spring 9, and press-spring's end seal 10, which distribute equally along the circle of the clock-internals in 4 parts, 4 balls per part and 16 locking positions in total.

Said transmitting circuit includes push-button A for opening movable pin in blind-hole, push-button B for unlocking, directional connection socket J4, roll-cipher coder chip U5 (Type ACM1330E), transmitting conducting module chip U6 (Type T630), and transmitting antenna TX1. The first code signal D1 of U5 is connected to power supply DC1 from pin 1 through A, and the second code signal D2 of U5 is connected to power supply DC1 through B or J4. Pin 3 of U5 is grounded. Pin 5 of U5 is connected to LED3. Pin 4 of U5 is connected with pin 3 of U6. Pin 8 of U5 is connected directly to power supply DC1. Pin 2 of U6 is connected to power supply DC1. Pin 4 of U6 is grounded. And pin 1 of U6 is connected to transmitting antenna TX1.

Said receiving circuit includes receiving chip U7 (Type T631), rolling decoder chip U8 (Type ACM1550D), calibration button C, and relays KA and KB. Pin 1 of U7 is connected to receiving antenna TX2. Pin 2 of U7 is connected to power supply DC2. Pin 3 of U7 is connected with pin 11 and pin 18 of U8 in parallel. Pin 4 of U7 is grounded. Pin 4 and pin 14 of U8 are connected together and go to power supply DC2. Pin 6 of U8 is connected to the base of transistor T4 through base resistor R24. Pin 7 of U8 is connected to the base of transistor T5 through resistor R23. Pin 2 and pin 10 of U8 are connected to indicating lamps LED4 and LED5 through current-limiting resistors R21 and R22, respectively. Pin 5 of U8 is grounded. The collector of T4 is connected to power supply DC2 through relay KA. And the collector of T5 is connected to power supply DC2 through relay KB.

Said telephone decoding control circuit includes telephone decryption chip U1 (Type CM8870), 51 series one-chip microcomputer U2 (Type AT89C2051), optical coupling chip U3, and directional connection sockets J1, J2 and J3. Pin 10 and pin 18 of U1 are connected with pin 3 of voltage stabilizer deplistor U4. Pins 5, 6 and 9 of U1 are grounded. Pin 7 and pin 8 of U1 are connected to acoustic surface filter XTAL1. Pin 1 and pin 4 of U1 are self short-circuited. Pin 3 and pin 4 of U1 are connected with the base of transistor T2 through current-limiting resistors R5 & R6 and capacitor C4 that are connected in series. Pin 16 and pin 17 of U1 are connected with pin 18 through bias resistor R8 and oscillation capacitor C5 in series. Pin 11, 12, 13, 14 and 15 of U1 are connected correspondingly with pins 19, 18, 17, 16 and 15 of U2. Pin 10 of U2 is grounded. The terminals of pins 3, 6, 7, 8 and 9 of U2 are unconnected. Pin 2 of U2 is connected to the base of transistor T3 through base resistor R14. Pin 1 of U2 is grounded through voltage-dividing resistor R17. Pin 4 and pin 5 of U2 are connected to acoustic surface filter XTAL2. Pin 11 of U2 is connected to up-link resistor R11, and pin 12 of U2 is connected to up-link resistor R12, and after that both of them are connected with pin 3 of voltage stabilizer deplistor U4 in parallel. Pin 13 of U2 is connected to indicating lamp LED1.

Further description is given below with attached drawings and practical example:

### BRIEF DESCRIPTION OF THE DRAWINGS

FIG. 1 is the sectional view of the blind keyhole structure of the lock-internals of this invention.

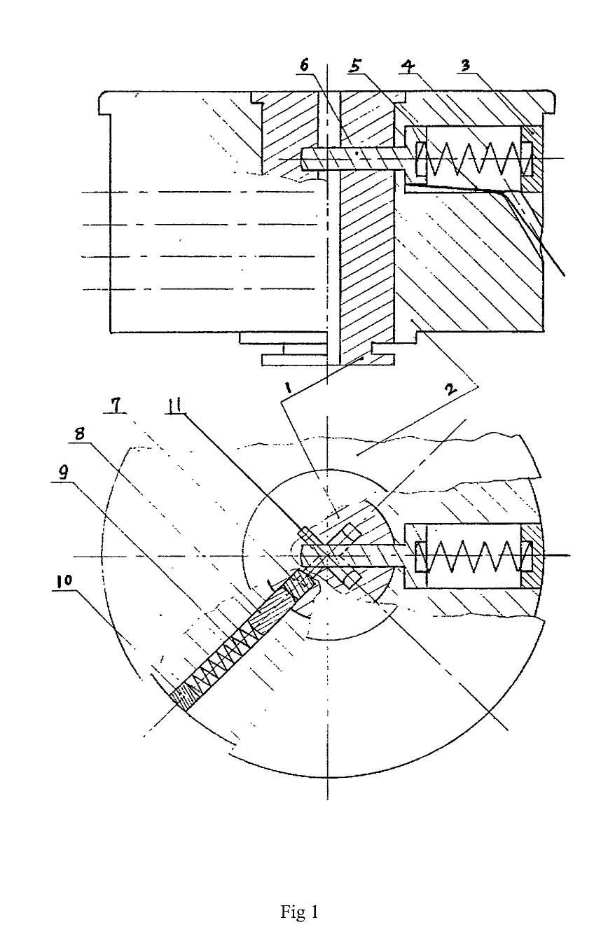

In FIG. 1, 1 is inner moving cock of the lock-internals, 2 is outer stationary case, 3 is blind-hole spring, 4 is blind-hole pin press-spring, 5 is tension flexible-shaft of blind-hole. 6 is movable pin key of blind hole, 7 is inner locking ball, 8 is outer locking ball, 9 is press-spring for locking ball, 10 is press-spring's end seal, and 11 is key positioning cross-groove.

FIG. 2 is the schematic diagram of rolling coding transmitting and receiving circuit of this invention.

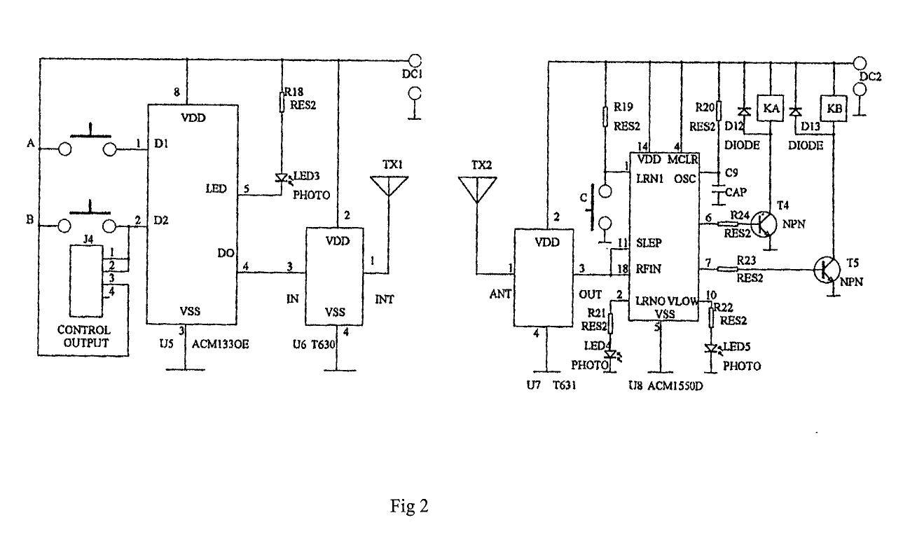

FIG. 3 is the schematic diagram of telephone decoding control circuit of this invention.

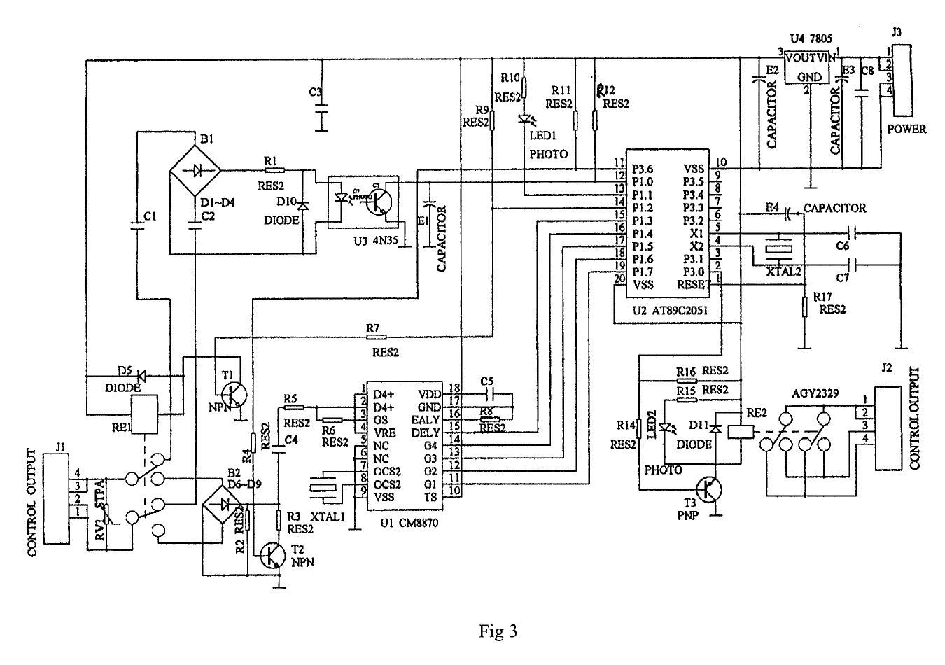

FIG. 4 is the block diagram of working process of this invention.

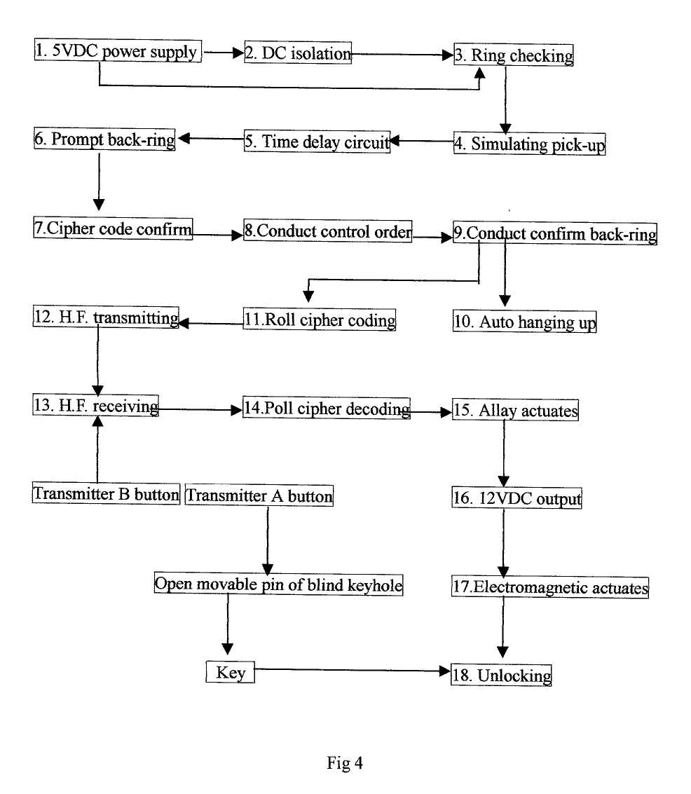

### DETAILED DESCRIPTION

When putting it into practice, all parts of the safety lock are manufactured by die casting, pressing or injection molding, which then are assembled. The coder's IC chip of this transmitter and receiver adopts roll-cipher coder IC chip of Microchip Co (AMC1330E as U5 and ACM1550D as U8), which is a built-in high secrecy system with 2⁶⁶ digits of transmitting code, 2³² digits of rolling code, 2⁶⁴ digits of programmable key-encrypting code, and 2³⁴ digits of primary code. The built-in crystal frequency stabilizer makes coding strictly synchronized. The cipher will absolutely not duplicated in 18 years. Its excellent performance can stand up to various scanners and codegrabers that could break ciphers. The secrecy and safety index reaches the trade and professional level of safety and protection products. Lithium cell is equipped for cases of power failure. Using this transmitter for direct unlocking is the only and most reliable safety means of current technology.

The telephone remote controlled unlocking decoding figure adopts above-mentioned roll-cipher coding of transmitter and related standards. The elements are selected and consisted of 51 series one-chip microcomputer produced by ATMEL Co, that is AT89C2051 as U2 chip and DTMF decoder, that is CM8870 as U1 chip. This scheme simplifies greatly the hardware design of the circuit. The working process of the circuit: DC isolation—ringing checking—converting ringing tone into pulse number (T/P)—simulating picking up handset—time delay circuit—back ring of prompt—confirming cipher and code—conducting control instruction—conducting back ring of confirming tone—automatic hanging up.

Working principle of the circuit: the directional connection socket J1 and external line of double audio frequency telephone set are connected in parallel. In case of no ringing signal, program-controlled telephone switching system gives a voltage of 50 VDC, which is isolated by DC isolating capacitors C1 and C2, and therefore optical coupling chip U3 is off-voltage. As a result, whole decoding control circuit doesn't work. When there is ringing signal coming in, the program-controlled telephone switching system gives voltage of 85 VAC at 25 Hz. C1 and C2 became conductive. The power is supplied through NC contact of RE1 to bridge rectifier D1-D4. After rectification, ringing pulse voltage is supplied to 4N35 optical coupling chip U3 discontinuously through current-limiting resistor R1, which makes its photosensitive diode conductive in half cycles. U4, TA7805 gives stable output of working power of 5 VDC that charges the electrolytic capacitor E1 through resistor R12. The electric potential of B+ point of E1 is increasing gradually with the increase of ring pulse number (the program-preset check time is 6). B+ point is P_{1.0}-terminal of U2. When the potential is increasing and equal to or a little higher than the potential of P_{1.1}-terminal that is co-phase comparator's output, indicator lamp LED1 lights, P_{3.6}-terminal is changed from low potential to high potential, P_{1.2}-terminal's potential is increased that makes transistor T1 conducted and therefore RE1 actuated. D6-D9 conduct rectification, supplying power for T2. U1, CM8870 decodes and simulates picking up handset. The potential of P_{3.7}-terminal of U2 increases and obtains alternate pulse signal, and sends back-ring of prompt (the program preset is 3 rings). Then, after inputting program-preset 5-digit primary cipher (can be altered to any 5-digit cipher), Q1-Q4 of U1 Decoder and DELY/pin14 carry out decoding. P₁₃₋₁₇-terminals of U2 conduct program setting, and checking and confirming of 5-digit cipher. After confirmation, low level is output from P_{3.0}-terminal that makes T3 work and therefore J2 actuates, points 1, 2 and 3 of J2 connection socket are conducted.

J2 and J4 are linked by line. Pin 2 of roll-cipher coder U5 is supplied with power, and ACM1330E works. U6, T630 transmits high frequency. U7, T631 receive signals. U8, ACM133D decodes and shapes the roll-cipher, and gives output that makes transistors T4 or T5 work and corresponding relay actuate. If KA actuates, electromagnetic in tension opens the blind hole of the lock. Or, if KB actuates, it controls the locking coil and opens the lock. By this way, whole procedures complete.

The present invention is novel in design and structure and convenient for use. It keeps absolute secrecy and is the only and most reliable safety lockset.

What is claimed is:

1. A safety lock with blind keyhole remote-controlled by transmitter or telephone is characterized by the fact that it includes rolling code transmitting and receiving circuits, telephone decoding control circuit, and inner moving cock 1 and outer stationary case 2 fixed with movable cross-bolted pin 3 in the lock-ball chamber of lock-internals.

2. The safety lock with blind keyhole remote-controlled by transmitter or telephone described in claim 1 is characterized by the fact that the lock-internals include blind-hole spring 3, blind-hole pin press-spring 4, key positioning cross-groove 11 with unequal distance, and tension flexible-shaft 5 of blind-hole pin. It also includes inner locking ball 7, outer locking ball 8, locking ball's press-spring 9, and press-spring's end seal 10, which distribute equally along the circle of the clock-internals in 4 parts, 4 balls per part and 16 locking positions in total.

3. The safety lock with blind keyhole remote-controlled by transmitter or telephone described in claim 1 is characterized by the fact that the transmitting circuit includes push-button A for opening movable pin in blind-hole, push-button B for unlocking, directional connection socket J4, roll-cipher coder chip U5 (Type ACM1330E), transmitting conducting module chip U6 (Type T630), and transmitting antenna TX1. The first code signal D1 of U5 is connected to power supply DC1 from pin 1 through A, and the second code signal D2 of U5 is connected to power supply DC1 through B or J4. Pin 3 of U5 is grounded. Pin 5 of U5 is connected to LED3. Pin 4 of U5 is connected with pin 3 of U6. Pin 8 of U5 is connected directly to power supply DC1. Pin 2 of U6 is connected to power supply DC1. Pin 4 of U6 is grounded. And pin 1 of U6 is connected to transmitting antenna TX1.

4. The safety lock with blind keyhole remote-controlled by transmitter or telephone described in claim 1 is characterized by the fact that the receiving circuit includes receiving chip U7 (Type T631), rolling decoder chip U8 (Type ACM1550D), calibration button C, and relays KA and KB. Pin 1 of U7 is connected to receiving antenna TX2. Pin 2 of U7 is connected to power supply DC2. Pin 3 of U7 is connected with pin 11 and pin 18 of U8 in parallel. Pin 4 of U7 is grounded. Pin 4 and pin 14 of U8 are connected together and go to power supply DC2. Pin 6 of U8 is connected to the base of transistor T4 through base resistor R24. Pin 7 of U8 is connected to the base of transistor T5 through resistor R23. Pin 2 and pin 10 of U8 are connected to indicating lamps LED4 and LED5 through current-limiting resistors R21 and R22, respectively. Pin 5 of U8 is grounded. The collector of T4 is connected to power supply DC2 through relay KA. And the collector of T5 is connected to power supply DC2 through relay KB.

5. The safety lock with blind keyhole remote-controlled by transmitter or telephone described in claim 1 is characterized by the fact that the telephone decoding control circuit includes telephone decryption chip U1 (Type CM8870), 51 series one-chip microcomputer U2 (Type AT89C2051), optical coupling chip U3, and directional connection sockets J1, J2 and J3. Pin 10 and pin 18 of U1 are connected with pin 3 of voltage stabilizer deplistor U4. Pins 5, 6 and 9 of U1 are grounded. Pins 7 and 8 of U1 are connected to acoustic surface filter XTAL1. Pin 1 and pin 4 of U1 are self short-circuited. Pin 3 and pin 4 of U1 are connected with the base of transistor T2 through current-limiting resistors R5 & R6 and capacitor C4 that are connected in series. Pin 16 and pin 17 of U1 are connected with pin 18 through bias resistor R8 and oscillation capacitor C5 in series. Pin 11, 12, 13, 14 and 15 of U1 are connected correspondingly with pins 19, 18, 17, 16 and 15 of U2. Pin 10 of U2 is grounded. The terminals of pins 3, 6, 7, 8 and 9 of U2 are unconnected. Pin 2 of U2 is connected to the base of transistor T3 through base resistor R14. Pin 1 of U2 is grounded through voltage-dividing resistor R17. Pin 4 and pin 5 of U2 are connected to acoustic surface filter XTAL2. Pin 11 of U2 is connected to up-link resistor R11, and pin 12 of U2 is connected to up-link resistor R12, and after that both of them are connected with pin 3 of voltage stabilizer deplistor U4 in parallel. Pin 13 of U2 is connected to indicating lamp LED1.
